(19) United States
(12) Patent Application Publication
(10) Pub. No.: US 2025/0108241 A1
(43) Pub. Date: Apr. 3, 2025

(54) SYSTEMS AND METHODS OF NOSECONES OF CONCEALED SPRINKLERS

(71) Applicant: Tyco Fire Products LP, Cranston, RI (US)

(72) Inventors: Kenneth Wayne Rogers, Horsham, PA (US); Johan M. Duran, Coventry, RI (US); Nicholas Rosa, Westport, MA (US)

(73) Assignee: Tyco Fire Products LP, Cranston, RI (US)

(21) Appl. No.: 18/895,653

(22) Filed: Sep. 25, 2024

Related U.S. Application Data
(60) Provisional application No. 63/586,005, filed on Sep. 28, 2023.

(51) Int. Cl. A62C 35/68; A62C 37/11

(52) U.S. Cl. CPC A62C 35/68; A62C 37/11

(57) ABSTRACT

A concealed sprinkler includes a body, a seal, an activation element, a deflector, and a nosecone. The body includes a passageway having an inlet and an outlet, and defines a longitudinal axis through the inlet and the outlet. The seal couples with the outlet. The activation element couples with the seal. The activation element changes from a first state to a second state responsive to a fire condition to allow the seal to be displaced from the outlet. The deflector is coupled with the body and positioned along the longitudinal axis. The nosecone is coupled with the deflector and includes a first portion positioned along the longitudinal axis, a second portion spaced from the first portion and extending further outward than the first portion, and a wall forming a step between the first portion and the second portion.

### CROSS-REFERENCE TO RELATED APPLICATIONS

The present application claims the benefit of and priority to U.S. Provisional Application No. 63/586,005, filed Sep. 28, 2023, the disclosure of which is incorporated herein by reference in its entirety.

### BACKGROUND

Sprinkler systems can be used to address fire conditions. For example, the sprinkler system can include one or more sprinklers that receive fluid from a fluid supply and output the fluid to address the fire condition.

### SUMMARY

At least one aspect relates to a concealed sprinkler. The concealed sprinkler can include a body, a seal, an activation element, a deflector, and a nosecone. The body includes a passageway having an inlet and an outlet, and defines a longitudinal axis through the inlet and the outlet. The seal couples with the outlet. The activation element couples with the seal. The activation element changes from a first state to a second state responsive to a fire condition to allow the seal to be displaced from the outlet. The deflector is coupled with the body and positioned along the longitudinal axis. The nosecone is coupled with the deflector and includes a first portion positioned along the longitudinal axis, a second portion spaced from the first portion and extending further outward than the first portion, and a wall forming a step between the first portion and the second portion.

At least one aspect relates to a nosecone of a sprinkler. The nosecone can include a first portion through which a longitudinal axis extends and a second portion. The first portion can have a first central surface perpendicular to the longitudinal axis and a first outer surface around the first central surface. The first outer surface can be angled relative to the first central surface. The nosecone can include a second portion spaced from the first portion and extending further outward than the first portion relative to the longitudinal axis. The nosecone can include a wall forming a step between the first portion and the second portion.

At least one aspect relates to a sprinkler assembly. The sprinkler assembly can include a body, a seal, an activation element, a deflector, a plurality of guide pins coupled with the deflector and the body, and a nosecone coupled with the deflector. The body can include a passageway having an inlet and an outlet that defines a longitudinal axis through the inlet and the outlet. The seal can be coupled with the outlet. The activation element can be coupled with the seal and can change from a first state to a second state responsive to a fire condition to allow the seal to be displaced from the outlet. The deflector can be positioned along the longitudinal axis. The nosecone can include a first portion positioned along the longitudinal axis, a second portion spaced from the first portion and extending further outward than the first portion, and a wall forming a step between the first portion and the second portion.

At least one aspect relates to a method of providing a deflector assembly, such as a deflector assembly of a concealed sprinkler assembly. The method can include providing a first portion of a nosecone. The method can include providing a second portion of the nosecone. The method can include providing a step between the first portion and the second portion. The method can include receiving the nosecone in a deflector.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of an example of a sprinkler system.

FIG. 2 is a cross-section view of an example of a concealed sprinkler assembly in an undeployed state.

FIG. 3 is a cross-section view of an example of a concealed sprinkler assembly in a deployed state.

FIG. 4 is a perspective view of an example of a nosecone of a concealed sprinkler assembly.

FIG. 5 is a top view of an example of a nosecone of a concealed sprinkler assembly.

FIG. 6 is a cross-section view of an example of a nosecone of a concealed sprinkler assembly.

FIG. 7 is a top view of an example of a deflector of a concealed sprinkler assembly.

FIG. 8 is a flow diagram of a method of providing a deflector assembly.

### DETAILED DESCRIPTION

Following below are more detailed descriptions of various concepts related to, and implementations of systems and methods of nosecones of concealed sprinklers, such as nosecones that can be implemented in concealed sprinkler assemblies. The various concepts introduced above and discussed in greater detail below can be implemented in any of numerous ways, including in residential ceiling implementations.

Concealed sprinklers can include and/or be coupled with a support cup and a cover plate. These components can be positioned around components of the sprinkler, such as a deflector and activation element, and between the sprinkler and a space that the sprinkler is to protect, such as a room in a building, including but not limited to residential buildings. The support cup can facilitate connecting the cover plate with the sprinkler. The cover plate can conceal components of the sprinkler relative to the space, providing for aesthetic benefits. The sprinkler can be installed in a cavity in a structure, such as a ceiling. For example, the sprinkler can be installed in a cavity defined in a concrete ceiling. The sprinkler can be installed in an open ceiling. The sprinkler can be connected with a wet pipe system.

A nosecone can be provided in the sprinkler. The nosecone can facilitate various operations, such as to direct through the sprinkler to the deflector so that the fluid can be outputted according a target spray pattern. The nosecone can be coupled with the deflector to be deployed along with the deflector responsive to activation of the sprinkler. The nosecone can be arranged to coincide with a longitudinal axis of the sprinkler along which fluid outputted from an outlet of the sprinkler is directed, and can be arranged between the outlet and the deflector so that the fluid contacts the nosecone (e.g., one or more surfaces of the nosecone) to be directed to the deflector. As such, the shape of the nosecone can significantly affect the performance of the sprinkler in outputted fluid according to the target spray pattern for a given application.

Nosecones in accordance with the present disclosure can be shaped to distribute water (e.g., to the deflector) at a given pressure in a manner to achieve a target spray pattern. For example, the nosecone can include shape features such as a plurality of stepped bodies, a height, a width and/or diameter, and/or angles of the surfaces of the respective bodies, to more effectively distribute the fluid outputted from the outlet of the sprinkler.

As an example, some sprinkler assemblies, such as sprinklers assemblies for concealed pendent sprinklers having a K-factor of 3.0 (among other K factors, such as for residential sprinkler applications), may have performance criteria relating to the spray pattern, such as criteria for absolute and/or relative amounts or distributions of fluid that are delivered to various regions below the sprinkler with respect to the K-factor of the sprinkler, flow rate of fluid provided to the sprinkler, and/or pressure of fluid provided to the sprinkler. Sprinkler assemblies having the nosecones (and/or deflectors) structured in accordance with the present disclosure can satisfy such performance criteria.

For example, a sprinkler assembly, such as a concealed sprinkler assembly, can include a body having an internal passageway extending between an inlet and an outlet. The sprinkler can include one or more frame arms extending from the body to a deflector assembly (which can be coupled with the frame arms by guide pins, for example), a seal in the outlet, and an activation element coupled with the seal. Responsive to a fire condition, the activation element can allow the seal to be released from the outlet so that fluid is outputted from the outlet towards the deflector assembly. The deflector assembly can include a nosecone and a deflector. The nosecone can include one or more bodies having respective surfaces facing the outlet. The bodies can be formed in a stepped manner. At least a subset of the surfaces of the body facing the outlet can have convex structures, such as constituent surfaces curved or angled away from the outlet. For example, a first surface can have a first width, a second surface can have a second width greater than the first width, and a third surface can have a third width greater than the second width, such that the first, second, and third surfaces are each exposed to fluid from the outlet; the first surface can have outer portions angled relative to a central portion, such as to be angled by obtuse angles so that the first surface forms a convex structure to guide fluid away from the first surface towards the deflector. The deflector can form an opening to receive the portion of the body of the nosecone forming the third surface. The deflector can be formed as a flat or planar member having a first dimension greater than a second dimension, the first dimension coinciding with where guide pins and/or frame arms are coupled with the deflector. The deflector can include a plurality of tines extending from a central body of the deflector, including tines having curved and/or flat ends edges. Various such structures of the nosecone and/or deflector can facilitate distributing fluid from the sprinkler according to the target spray pattern.

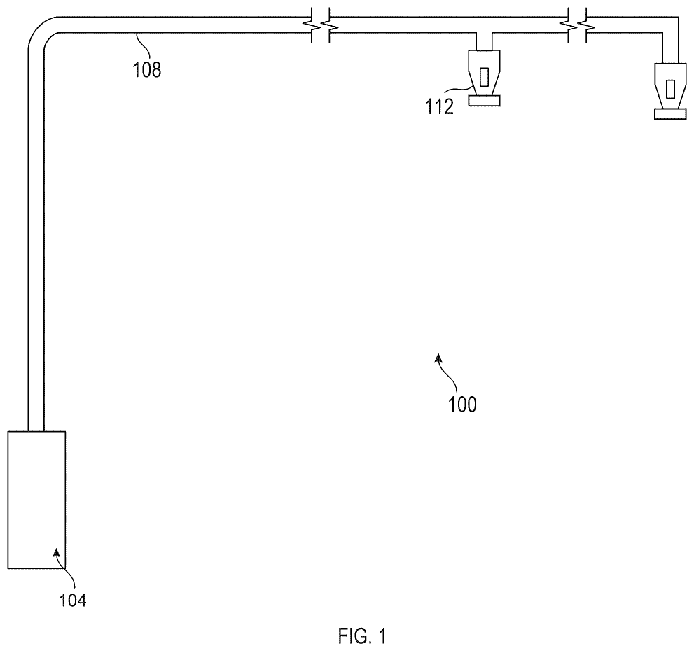

FIG. 1 depicts an example of a sprinkler system 100. The sprinkler system 100 can include a fluid supply 104. The fluid supply 104 can store fluids to be used to address a fire condition, which can include at least one of water and one or more fire suppression agents.

The sprinkler system 100 can include one or more pipes 108. The pipes 108 can be connected with the fluid supply 104 and extend from the fluid supply 104. The pipes 108 can extend through a structure, such as a building. Fluid from the fluid supply 104 can be present in the pipes 108 and flow through the pipes 108. The pipes 108 can include any of a variety of conduits that can be used to flow fluid (e.g., water or other fire suppression agents), including but not limited to piping, tubing, metal pipes, rigid pipes, or polymeric (e.g., chlorinated polyvinyl chloride (CPVC)) pipes.

The sprinkler system 100 can include at least one sprinkler 112. The sprinkler 112 can receive fluid from the fluid supply 104 through the one or more pipes 108 and output the fluid to address a fire condition. The sprinkler 112 can be a concealed sprinkler. The sprinkler 112 can have various K-factors, such as K-factors used for residential sprinkler applications. For example, the sprinkler 112 can have a K-factor including but not limited to a K-factor of 3.0. The sprinkler 112 can have a K-factor greater than or equal to 2.0 and less than or equal to 40.0. The sprinkler 112 can have a nominal K-factor of, for example and without limitation, 2.8, 3.0, 4.2, 5.6, 8.0, 11.2, 14.0, 16.8, 22.4, 25.2, and 36.0. The sprinklers 112 can be used for residential buildings, commercial buildings, or storage buildings or warehouses, for example and without limitation. The sprinklers 112 can be used in dry sprinkler and/or wet sprinkler systems.

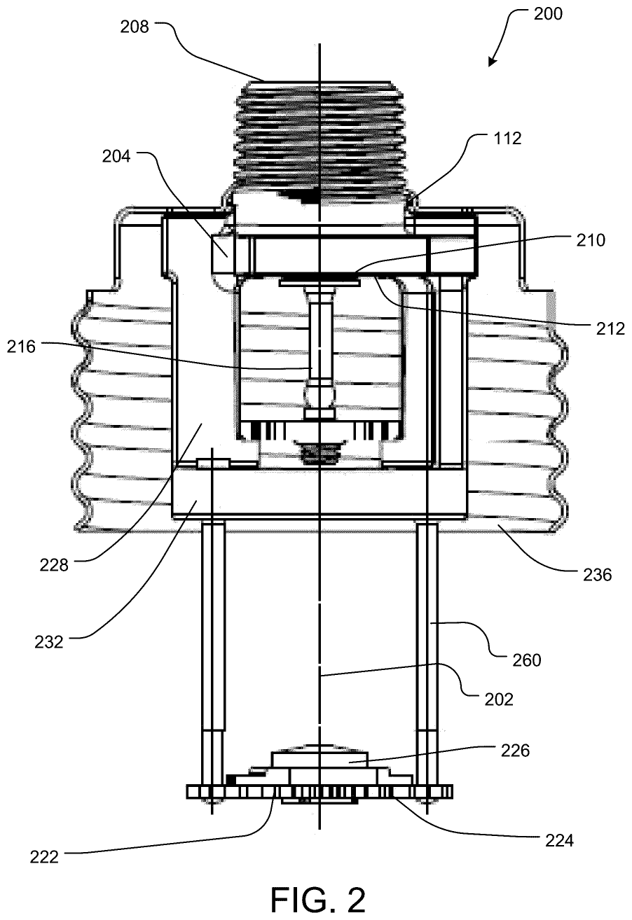

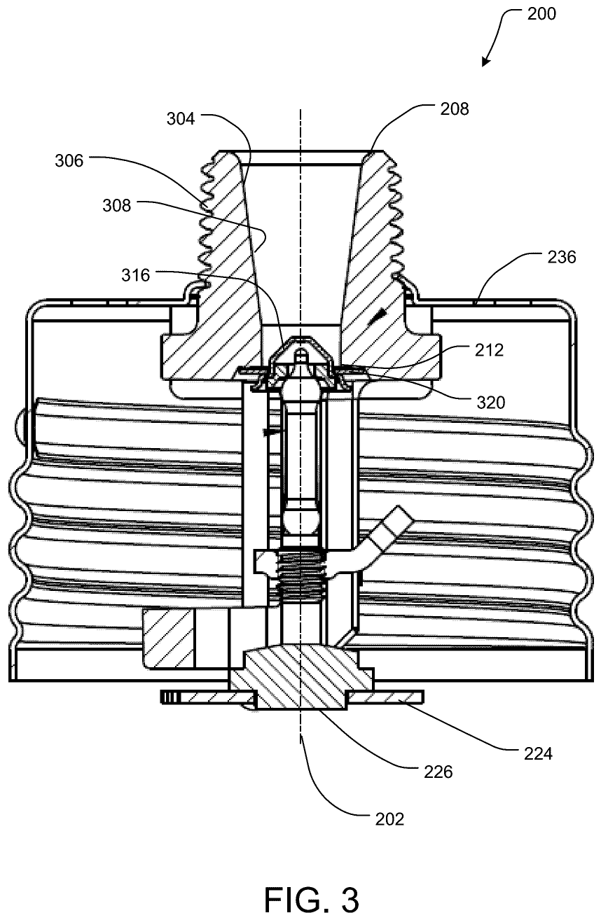

The one or more pipes 108 can extend through at least a portion of a building structure. A cavity can be formed in the building structure to receive the sprinkler 112 (as well as sprinkler assembly 200 described with reference to FIGS. 2 and 3). The sprinkler 112 can be at least partially positioned in the cavity to be coupled with the one or more pipes 108. The cavity can be at least partially open to a space below the ceiling, such as a space that the sprinkler 112 is used to protect in the event of a fire condition. The sprinkler 112 can be arranged in or coupled with a sprinkler box provided in the cavity. The sprinkler box can be a box used to support or install the sprinkler 112 in the ceiling, such as in a concrete ceiling installation.

FIGS. 2 and 3 depict an example of a sprinkler assembly 200 that includes the sprinkler 112. The sprinkler 112 can include a body 204 that defines a fluid passageway 304 extending from an inlet 208 (which can be coupled with the one or more pipes 108) to an outlet 212. The passageway 304 can extend along a longitudinal axis 202 and can have an inner wall 308 having various form factors; for example, as depicted in FIG. 3, the inner wall 308 can taper in a direction along the longitudinal axis 202 from the inlet 208 to the outlet 212. The body 204 can include an engagement member 306, such as threads, to couple the sprinkler 112 with the one or more pipes 108.

The sprinkler 112 can include a seal 210 that seals the outlet 212. The seal 210 can include a button 316 and a spring 320 (e.g., Belleville spring) coupled with the button 316 between the button 316 and the inner wall 308 of the passageway 304.

The sprinkler 112 can include an activation element 216 coupled with the seal 210 to maintain the seal 210 in a first state in which the seal 210 seals the outlet 212. The activation element 216 can include one or more components that change state from the first state to a second state by being activated responsive to a fire condition (e.g., responsive to temperature or a rate of rise of temperature meeting or exceeding a threshold value). In the second state, at least a portion of the activation element 216 can be separated from a remainder of the activation element 216.

As depicted in FIGS. 2 and 3, the activation element 216 can include a bulb that includes a fluid that expands to break the bulb. The activation element 216 can include a fusible link (e.g., link components coupled with solder) that separates responsive to the fire condition to break. For example, by changing state, the activation element 216 can discontinue applying a force against the seal 210, allowing the seal 210 to move away from the outlet 212 due to pressure from fluid in the passageway 304 to allow fluid to flow through the outlet 212.

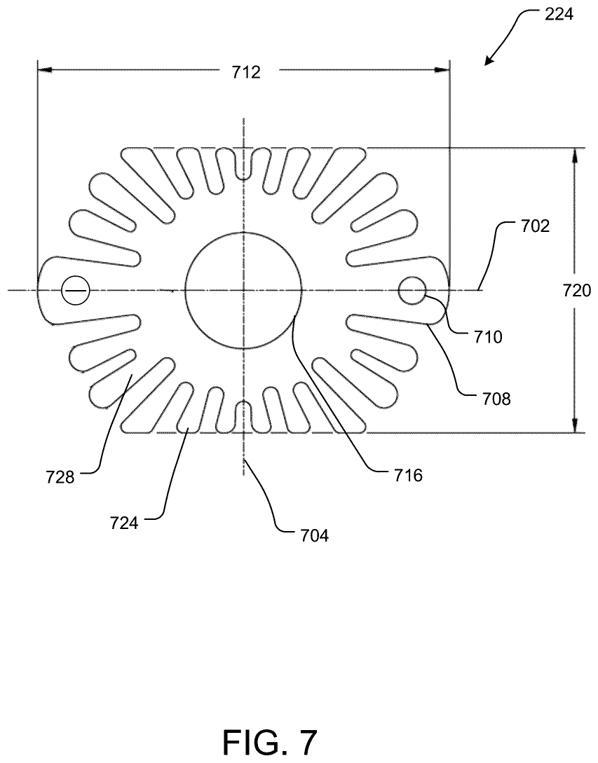

The sprinkler 112 can include a deflector assembly 222 downstream of the outlet 212. The deflector assembly 222 can include a deflector 224 coupled with a nosecone 226. The deflector assembly 222 can receive the fluid that flows out of the outlet 212 and deflect the fluid according to a target spray pattern (e.g., a spray pattern corresponding to the geometry of the nosecone 226 and/or deflector 224). The deflector 224 and nosecone 226 can be formed as separate components and/or integrally or monolithically formed. For example, as described further with reference to FIG. 7, the deflector 224 can form an opening to receive the nosecone 226. The deflector assembly 222 can be coupled with the body 204 (e.g., by guide pins 260) so that the longitudinal axis 202 extends through the deflector 224 and the nosecone 226, such as to extend through a central axis of each of the deflector 224 and the nosecone 226.

The sprinkler 112 can include at least one frame arm 228 extending from the body 204. The frame arms 228 can extend along the longitudinal axis 202 and outward of the longitudinal axis 202 and the activation element 216, to a base 232 extending across between the frame arms 228.

The sprinkler 112 can include at least one guide pin 260 coupled with a respective frame arm 228 of the at least one frame arm 228. The guide pins 260 can be coupled with the deflector 224, and can facilitate deploying the deflector 224 responsive to a fire condition. For example, responsive to various triggers corresponding to the fire condition (e.g., cover plate being released; deflector 224 being released; fluid contacting the deflector 224) the guide pins 260 can be driven away from the inlet 208 to move the deflector 224 into a deployed position as shown in FIG. 2 further from the inlet 208 (e.g., relative to the position shown in FIG. 3).

As depicted in FIGS. 2 and 3, the sprinkler assembly 200 can include a cup 236. The cup 236 can be a support cup, such as a structure to support the sprinkler 112 for installation as in a ceiling or other concealed location. The cup 236 can be made of various materials, including metal, composite, and/or polymeric materials. For example, the cup 236 can be made of a steel material.

The cup 236 can be coupled with the body 204 (e.g., an end of the body proximate the engagement member 206). The cup 236 can extend outward of the frame arms 228, such as to at least partially form a housing around the sprinkler 112 and components thereof.

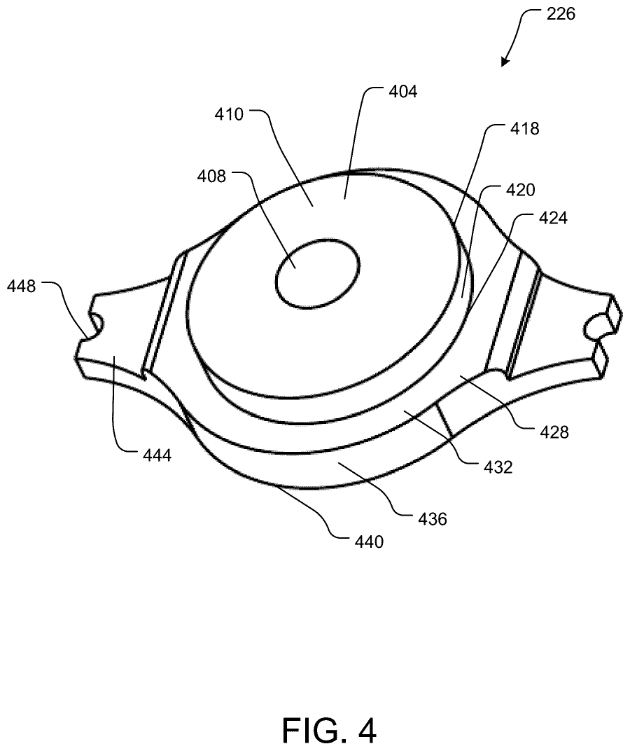

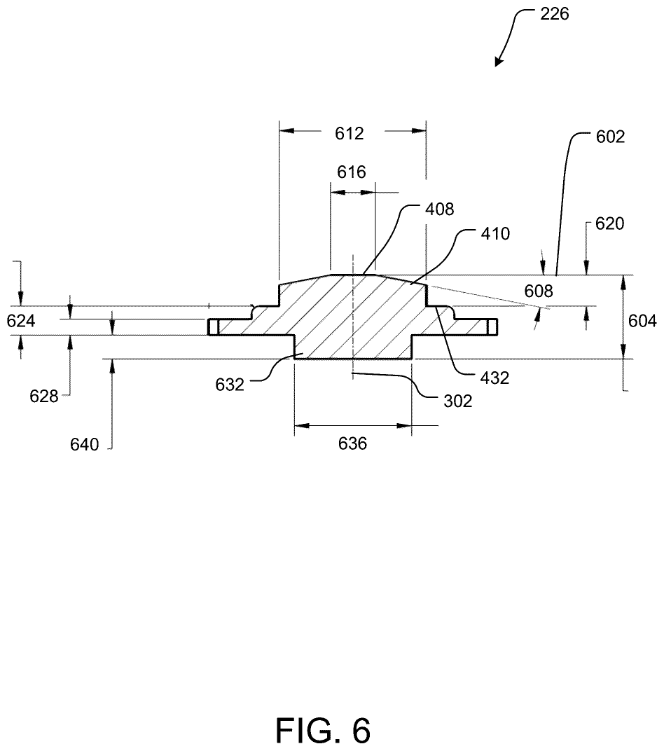

FIGS. 4-6 depict an example of the nosecone 226. As described with reference to FIGS. 2 and 3, the nosecone 226 can be coupled with the deflector 224, such as to be received by the deflector 224, or to be integrally or monolithically formed with the deflector 224. The nosecone 226 can be made of the same or different material(s) as the deflector 224. The nosecone 226 can be made, for example, of metal, polymeric, and/or composite materials. As depicted in FIG. 6, the longitudinal axis 202 can coincide with a central axis of the nosecone 226 (e.g., while the nosecone 226 is coupled with the body 204), such that fluid flow from the outlet 212 can flow along the longitudinal axis 202 towards the nosecone 226 to contact the nosecone 226 and be (re) directed by the nosecone 226 towards the deflector 224. The nosecone can have a height 604, which can be greater than or equal to 0.1 inches and less than or equal to 0.5 inches (e.g., greater than or equal to 0.15 inches and less than or equal to 0.35 inches; greater than or equal to 0.2 inches and less than or equal to 0.3 inches; 0.26 inches).

The nosecone 226 can include a first portion 404, which can form a convex shape relative to the fluid from the outlet 212. For example, the first portion 404 can one or more surfaces, such as a central first surface 408 and at least one outer first surface 410 extending around the central first surface 408. The central first surface 408 can be flat. For example, the central first surface 408 can define a plane 602 perpendicular to the longitudinal axis 202 (which can, for example, be parallel with respective longitudinal axis of the guide pins 260, though the guide pins 260 may also extend in directions different than the longitudinal axis 202). Due to the orientation of the nosecone 226 while coupled with the body 204, the central first surface 408 can be closest to the outlet 212.

The outer first surface 410 can be contiguous with the central first surface 408 and extend outward from the central first surface 408 relative to the longitudinal axis 202. The outer first surface 410 can be circular. The outer first surface 410 can extend away from the plane 602 (and the outlet 212) by an angle 608. The angle 608 can be formed for the outer first surface 410 to direct fluid contacting the first portion 404 outward towards one or more portions of the deflector 224. For example, the angle 608 can be greater than or equal to 5 degrees and less than or equal to 20 degrees (e.g., greater than or equal to 8 degrees and less than or equal to 15 degrees; 11 degrees). The first portion 404 can have a height 620, which can be greater than or equal to 0.02 inches and less than or equal to 0.2 inches (e.g., greater than or equal to 0.05 inches and less than or equal to 0.15 inches; 0.1 inches). Forming the outer first surface 410 at the angle 608 (e.g., as opposed to a step between the flat central portion represented by the first surface 408 and the flat portion represented by the second surface 432) can allow for more efficient transfer of fluid to the deflector 224.

Along with the angle 608, the central first surface 408 and outer first surface 410 can have respective diameters for directing a central portion of fluid from the outlet 212 in accordance with the target spray pattern. For example, the central first surface 408 can have a diameter 612, which can be greater than or equal to 0.05 inches and less than or equal to 0.5 inches (e.g., greater than or equal to 0.08 inches and less than or equal to 0.3 inches; greater than or equal to 0.1 inch and less than or equal to 0.2 inches; 0.14 inches). The outer first surface 410 can have a diameter 616, which can be greater than or equal to 0.1 inches and less than or equal to 1 inch (e.g., greater than or equal to 0.25 inches and less than or equal to 0.8 inches; greater than or equal to 0.4 inches and less than or equal to 0.6 inches; 0.46 inches). A ratio of the diameter 612 to the diameter 616 can be between 1.5:1 and 5:1 (e.g., between 2:1 and 4:1; between 2.8:1 and 3.7:1; 3.3:1). The ratio of the diameter 612 to the diameter 616 can facilitate controlling how much of the fluid outputted through the outlet 212 is directed along the angled outer first surface 410.

The first portion 404 can be sized in a manner relative to the outlet 212 to direct fluid from the outlet 212 for distribution according to the target spray pattern. For example, the outlet 212 can have a diameter 340 less than the diameter 616 (e.g., such that any expansion of fluid upon output from the outlet 212 is directed to the first portion 404. The diameter 340 can be greater than the diameter 612.

As depicted in FIGS. 4-6, the first portion 404 can include or extend into a wall 420 extending from an edge 418 of the outer first surface 410. For example, the wall 420 can extend in a direction parallel with the longitudinal axis 202, such that the edge 418 can form a ninety-degree transition from the outer first surface 410 to the wall 420 (e.g., to expose second surface 428). The wall 420 can extend at an angle (e.g., non-perpendicular angle) relative to the longitudinal axis 202. The wall 420 can extend from the edge 418 to an edge 424.

The nosecone 226 can include a second portion 428. The second portion 428 can receive fluid from the outlet 212 directed outward of the first portion 404 and direct the fluid outward to the deflector 224 and/or according to the target spray pattern. For example, by providing the first portion 404 and second portion 428 to have varying shapes and/or surfaces as described herein, the fluid can more effectively be directed to the deflector 224 and/or the environment by at least one of the first portion 404 or the second portion 428.

The second portion 428 can extend from the edge 418 outward relative to the longitudinal axis 202, such as to include a second surface 432 extending outward from the edge 418. The first portion 404 and the second portion 428 can be integrally or monolithically formed, or can be made from separate members. The second portion 428 can include a wall 436 extending from the edge 424 to an edge 440.

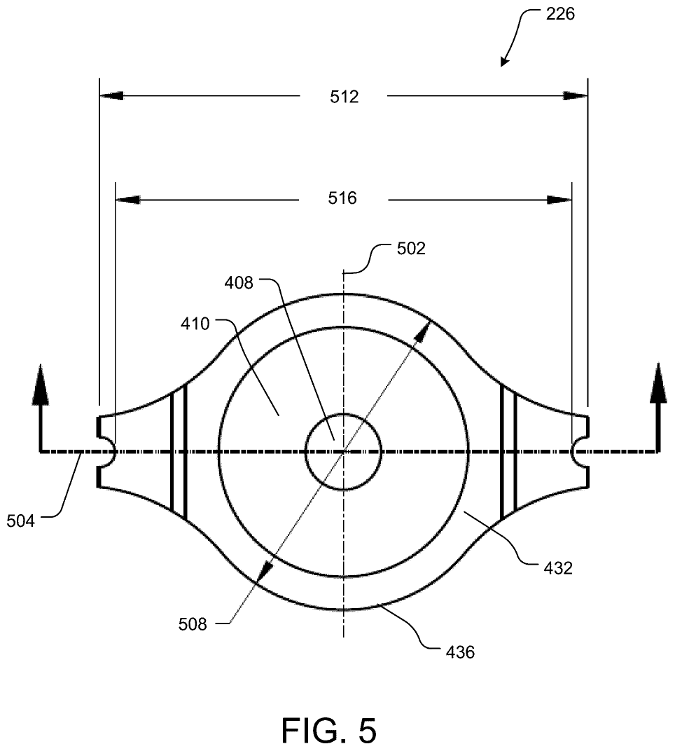

The second surface 432 and wall 436 can be wider (e.g., have a greater width and/or diameter) than the outer first surface 410 and the wall 420, respectively, such as to be sized to direct selected portions of fluid to the outer first surface 410 or the second surface 432 for further output according to the target spray pattern. For example, as depicted in FIG. 5, the wall 436 (e.g., a portion of the wall 436 corresponding to axis 502 perpendicular to the longitudinal axis 202 and an axis 504) can have a width 508 (e.g., diameter). The width 508 can be greater than the diameter 616. For example, the width 508 can be greater than or equal to 0.2 inches and less than or equal to 1.2 inches (e.g., greater than or equal to 0.3 inches and less than or equal to 0.8 inches; greater than or equal to 0.4 inches and less than or equal to 0.7 inches; 0.59 inches). The second portion 428 can have a height 624, which can be greater than or equal to 0.03 inches and less than or equal to 0.2 inches (e.g., greater than or equal to 0.05 inches and less than or equal to 0.15 inches; greater than or equal to 0.08 inches and less than or equal to 0.1 inch; 0.9 inches). The nosecone 226 can be symmetrical about the axis 502 (e.g., about a plane in which the axis 502 and the axis 202 lie), and can be wider on each side of the axis 502 than along the axis 502.

As depicted in FIGS. 4-6, the second portion 428 can include at least one frame connector 444. The frame connectors 444 can extend further outward from the longitudinal axis 202 than portions of the wall 436 between the frame connectors 444, such as to align the frame connectors 444 with the frame arms 228 (e.g., along a longer length portion of the deflector 224). For example, the frame connectors 444 can be shaped to be positioned adjacent to at least one of the frame arms 228 or the guide pins 260, such as to include receivers 448 to face the guide pins 260. The frame connectors 444 can have a lesser height than the wall 436, which can facilitate coupling the nosecone 226 with the frame arms 228.

The frame connectors 444 can have a width 512, which can be greater than the width 508. The width 512 can be defined along the axis 504. For example, the width 512 can be greater than or equal to 0.25 inches and less than or equal to 2 inches (e.g., greater than or equal to 0.5 inches and less than or equal to 1.5 inches; greater than or equal to 0.8 inches and less than or equal to 1.2 inches; 0.9 inches). The receivers 448 can extend inward from the edge of the frame connectors 444, such as to have a width 516 less than the width 512. For example, the width 516 can be greater than or equal to 0.5 inches and less than or equal to 1.5 inches (e.g., greater than or equal to 0.7 inches and less than or equal to 1.2 inches; greater than or equal to 0.8 inches and less than or equal to 0.9 inches; 0.85 inches). The width 512 can be less than a width 712 of a longer extent of the deflector 224 as depicted in FIG. 7.

The nosecone 226 can have a third portion 632, which can extend from the second portion 428. The third portion 632 can be integrally formed with the second portion 428, or can be formed as a separate member coupled with the second portion 428. The third portion 632 can be narrower than the second portion 428 so that the third portion 632 can be received in the opening formed by the inner wall 716 of the deflector 224. The third portion 632 can have a width 636, which can be greater than or equal to 0.1 inch and less than or equal to 0.6 inches (e.g., greater than or equal to 0.2 inches and less than or equal to 0.5 inches; greater than or equal to 0.3 inches and less than or equal to 0.4 inches; 0.37 inches). The third portion 632 can have a height 640, which can be greater than or equal to 0.03 inches and less than or equal to 0.25 inches (e.g., greater than or equal to 0.04 inches and less than or equal to 0.15 inches; greater than or equal to 0.06 inches and less than or equal to 0.1 inches; 0.075 inches).

FIG. 7 depicts an example of the deflector 224. The deflector 224 can couple with the nosecone 226, such as to receive the nosecone 226, and can receive fluid from the outlet 212 (e.g., directly from the outlet 212 and/or as directed by the nosecone 226 and/or off of other components of the sprinkler 112) to direct the fluid according to the target spray pattern. The deflector 224 can have a flat and/or planar body 706 extending out to a plurality of tines 708 forming a perimeter edge of the deflector 224. The body 706 can extend in a plane defined by a first axis 702 and a second axis 704.

The body 706 can include an inner wall 716, which can receive the third portion 632 of the nosecone 226. For example, the third portion 632 can be received by the inner wall 716 (e.g., can be received by an opening formed by the inner wall 716) so that the deflector 224 contacts the second portion 428 of the nosecone 226.

The deflector 224 can have a width 712 defined along the first axis 702, and can have a height 720 defined along the second axis 704. The width 712 can be greater than the height 720, such as to enable the deflector 224 to direct fluid towards corners of spaces and/or be used in rectangular spaces. The width 712 can be greater than or equal to 0.5 inches and less than or equal to 4 inches (e.g., greater than or equal to 0.8 inches and less than or equal to 2 inches; greater than or equal to 1 inch and less than or equal to 1.8 inches; 1.3 inches). The height 720 can be greater than or equal to 0.2 inches and less than or equal to 2 inches (e.g., greater than or equal to 0.4 inches and less than or equal to 1.5 inches; greater than or equal to 0.8 inches and less than or equal to 1.2 inches; 0.9 inches). The deflector 224 can include at least one guide pin receiver 710 to receive and/or couple with respective guide pin(s) 260; the guide pin receivers 710 can be formed along the first axis 702 corresponding to the longer extent of the deflector 224.

The tines 708 can have various sizes (e.g., angular extents) and spacings between tines 708 to direct fluid to portions of spaces, such as to walls, windows, and/or corners of spaces. For example, as depicted in FIG. 7, at least a first subset 724 of tines 708 closer to the second axis 704 can extend a same distance from the first axis 702, while at least a second subset 728 of tines 708 further from the second axis 704 can extend to varying distances from the first axis 702 and the second axis 704. For example, the first subset 724 can form a straight portion of a perimeter of the deflector 224, while the second subset 728 can form a curved (e.g., circular, convex) portion of the perimeter.

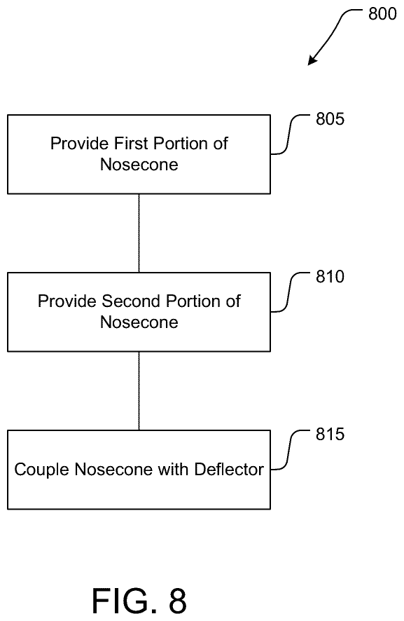

FIG. 8 depicts an example of a method 800 of providing a nosecone, such as a nosecone of a concealed sprinkler assembly. The method can be implemented by performing various types of assembly and/or manufacturing operations.

At 805, a first portion of the nosecone can be provided. The first portion can include a central surface and an outer surface extending at an angle to the central surface. At 810, a second portion of the nosecone can be provided. The second portion can be stepped away from the first portion, such as to have a surface extend outward from a wall of the first portion extending from the outer surface. At 815, the nosecone can be received in a deflector. The deflector and nosecone (e.g., an assembly of the deflector and nosecone) can be coupled with a sprinkler, such as to be connected with one or more guide pins of the sprinkler.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A concealed sprinkler, comprising:
a body that includes a passageway, the passageway has an inlet and an outlet, the passageway defines a longitudinal axis through the inlet and the outlet;
a seal that seals the outlet;
an activation element coupled with the seal, the activation element to change from a first state to a second state responsive to a fire condition to allow the seal to be displaced from the outlet;
a deflector coupled with the body and positioned along the longitudinal axis; and
a nosecone coupled with the deflector, the nosecone comprising a first portion positioned along the longitudinal axis, a second portion spaced from the first portion and extending further outward than the first portion, and a wall forming a step between the first portion and the second portion.

2. The concealed sprinkler of claim 1, comprising:
the wall extends between an outer edge of the first portion and the second portion.

3. The concealed sprinkler of claim 1, comprising:
The first portion comprises a first surface through which the longitudinal axis passes and a second surface outward from the first surface, the second surface angled relative to the first surface and extending from the first surface to the wall.

4. The concealed sprinkler of claim 1, comprising:
the wall is parallel with the longitudinal axis, and a ratio of a diameter of the second portion to a diameter of the first portion is greater than or equal to 2:1 and less than or equal to 4:1.

5. The concealed sprinkler of claim 1, comprising:
the first portion comprises a first surface through which the longitudinal axis passes and a second surface outward from the first surface, the second surface angled relative to the first surface; and
the second portion comprises a third surface that extends further from the longitudinal axis than the second surface.

6. The concealed sprinkler of claim 1, comprising:
the first portion comprises a first surface perpendicular to the longitudinal axis and a second surface outward from the first surface, the second surface angled relative to the first surface.

7. The concealed sprinkler of claim 1, comprising:
the first portion comprises a first surface perpendicular to the longitudinal axis and a second surface outward from the first surface, the second surface angled relative to the first surface at an angle greater than or equal to 5 degrees and less than or equal to 20 degrees.

8. The concealed sprinkler of claim 1, comprising:
a surface of the first portion facing the outlet is at least partially convex.

9. The concealed sprinkler of claim 1, comprising:
the deflector has a greater width along a first axis perpendicular to the longitudinal axis than a second axis perpendicular to the first axis and to the longitudinal axis.

10. The concealed sprinkler of claim 1, comprising:
the first portion has a first diameter less than a diameter of the outlet and the second portion has a second diameter greater than the diameter of the outlet.

11. The concealed sprinkler of claim 1, comprising:
a width of the nosecone is less than a width of the deflector.

12. The concealed sprinkler of claim 1, comprising:
a support cup coupled with the body.

13. A nosecone of a sprinkler, comprising:
a first portion through which a longitudinal axis extends, the first portion having a first central surface perpendicular to the longitudinal axis and a first outer surface around the first central surface, the first outer surface angled relative to the first central surface;
a second portion spaced from the first portion and extending further outward than the first portion relative to the longitudinal axis; and
a wall forming a step between the first portion and the second portion.

14. The nosecone of claim 13, comprising:
the wall extends between an outer edge of the first portion to the second portion.

15. The nosecone of claim 13, comprising:
the wall is parallel with the longitudinal axis, and a ratio of a diameter of the second portion to a diameter of the first portion is greater than or equal to 2:1 and less than or equal to 4:1.

16. The nosecone of claim 13, comprising:
the second portion comprises a second surface that is parallel with and extends further from the longitudinal axis than the first central surface.

17. The nosecone of claim 13, comprising:
the second surface is angled relative to the first surface at an angle greater than or equal to 5 degrees and less than or equal to 20 degrees.

18. A sprinkler assembly, comprising:
a body that includes a passageway, the passageway has an inlet and an outlet, the passageway defines a longitudinal axis through the inlet and the outlet;
a seal to couple with the outlet;
an activation element coupled with the seal, the activation element to change from a first state to a second state responsive to a fire condition to allow the seal to be displaced from the outlet;
a deflector coupled with the body and positioned along the longitudinal axis;
a plurality of guide pins coupled with the deflector and the body; and
a nosecone coupled with the deflector, the nosecone comprising a first portion positioned along the longitudinal axis, a second portion spaced from the first portion and extending further outward than the first portion, and a wall forming a step between the first portion and the second portion.

19. The sprinkler assembly of claim 18, comprising:
the wall extends between an outer edge of the first portion and the second portion.

20. The sprinkler assembly of claim 18, comprising:
the first portion comprises a first surface through which the longitudinal axis passes and a second surface outward from the first surface, the second surface angled relative to the first surface and extending from the first surface to the wall;
the second portion comprises a third surface that extends further from the longitudinal axis than the second surface; and
the first portion has a first diameter less than a diameter of the outlet and the second portion has a second diameter greater than the diameter of the outlet.
